(19) United States
(12) Patent Application Publication
(10) Pub. No.: US 2019/0388718 A1
(43) Pub. Date: Dec. 26, 2019

(54) FIRE EXTINGUISHING SYSTEM VALVE, IN PARTICULAR WET ALARM VALVE, DRY ALARM VALVE OR SPRAY WATER VALVE, AND FIRE EXTINGUISHING SYSTEM COMPRISING SAME

(71) Applicant: MINIMAX GMBH & CO. KG, Bad Oldesloe (DE)

(72) Inventors: Matthias POHL, Stubben (DE); Frank STACKOWITZ, Ratzeburg (DE); Peter KEMPF, Bad Oldesloe (DE); Georg KUNERT, Wismar (DE)

(21) Appl. No.: 16/469,591

(22) PCT Filed: Dec. 14, 2017
(86) PCT No.: PCT/EP2017/082800

§ 371 Date: Jun. 13, 2019

(30) Foreign Application Priority Data
Dec. 15, 2016 (DE) 10 2016 124 475.9

(51) Int. Cl. A62C 35/60; A62C 35/68; A62C 35/64; A62C 37/50

(52) U.S. Cl. CPC A62C 35/605; A62C 37/50; A62C 35/64; A62C 35/68

(57) ABSTRACT

The invention relates to a fire extinguishing system valve (1), in particular a wet alarm valve, dry alarm valve or spray water valve, comprising a housing (2, 3) which has a fluid inlet chamber (8), a fluid outlet chamber (9) and a closing body (4a) which is movable to and fro between a blocking state and a release state, wherein, in the release state, the fluid inlet chamber (8) and the fluid outlet chamber (9) communicate with each other directly in a fluid-conducting manner, and, in the blocking state, the closing body (4a) prevents the direct communication between the fluid inlet chamber (8) and the fluid outlet chamber (9) characterized by a bypass line (10) which is integrated in the housing and is connected to the fluid inlet chamber (8) and the fluid outlet chamber (9) in a fluid-conducting manner.

The present invention relates to a fire extinguishing system valve, in particular a wet alarm valve, dry alarm valve or spray water valve, comprising a housing which has a fluid inlet chamber, a fluid outlet chamber and a closing body which is movable to and fro between a blocking state and a release state, wherein, in the release state, the fluid inlet chamber and the fluid outlet chamber communicate with each other directly in a fluid-conducting manner, and, in the blocking state, the closing body prevents the direct communication between the fluid inlet chamber and the fluid outlet chamber. The invention furthermore relates to a fire extinguishing system, in particular a sprinkler system, comprising one or more fluid lines in which a fire extinguishing system valve of the above-designated type for blocking and releasing the fluid line is arranged.

Fire extinguishing systems and fire extinguishing system valves of the above-designated type are known in general. Within the context of the present invention, fire extinguishing system valves are understood as meaning the generic type both of passive and active alarm valves for use in fire extinguishing systems, especially fire extinguishing systems having water-based solvents (for example, water, water with additives and the like). The most prominent representatives of these types of valves are wet alarm valves and dry alarm valves and also spray water valves. Passive alarm valves are understood here as meaning that they automatically open when predetermined pressure differences between the inlet side and outlet side are exceeded, and an alarm is generally triggered by the valves themselves in reaction to the detection of said opening state, for example by means of a pressure switch which is arranged in an external alarm line and via which an alarm means, such as, for example, an electrically operated alarm horn, is controlled, and/or directly by controlling the extinguishing agent flow to a hydraulically operated alarm means fluidically connected to the alarm valve, such as, for example, a water-operated alarm bell. Up to now, optical displays have also been arranged in the region of the alarm valves instead of or in addition to hydraulically operated alarm bells in order, when there are a multiplicity of alarm valves arranged in parallel, to be able better to differentiate which of the alarm valves has been opened.

Active alarm valves are understood as meaning that, after input of a corresponding signal from external fire identification means or as a function of external control interventions, the valves actively release the fluid flow, by opening of the valve, and trigger an alarm. A common feature of the aforementioned types of valve is that they are frequently installed in fire extinguishing systems for long periods of time without having to be used, and it is important that said valves operate reliably in a serious situation.

Fire extinguishing system valves, in particular wet alarm valves, are frequently connected in the blocking state on the inlet side to a water supply which has a substantially constant supply pressure, provided, for example, by a pump system. However, up to now, pressure fluctuations may nevertheless occur in the water supply, in particular in such configurations if the fire extinguishing systems are connected directly to the drinking water network. Fire extinguishing system valves, in particular wet alarm valves, are conventionally connected on the outlet side to a pipe network in which sprinklers or nozzles are provided. Pressure fluctuations also arise here, for example due to temperature fluctuations. In order to be able to compensate in particular for the pressure fluctuations on the outlet side of the fire extinguishing system valve by feeding in extinguishing fluid, without an alarm having to be triggered in this case, in addition to the fire extinguishing system valve fire extinguishing systems frequently have circumventing or bypass lines which are installed at a fire extinguishing system valve station by means of external pipework in order to be able to convey extinguishing fluid from the admission side to the discharge side of the fire extinguishing system valve without the latter having to be opened in this case.

Fire extinguishing system valves are furthermore known in which the closing body of the valve itself has a small passage opening through which a small volumetric flow can flow from the inlet side to the outlet side of the fire extinguishing system valve. Said known solutions share the problem that the structural outlay is high and the maintenance of such systems is complicated. Furthermore, retrofitting or adaptation to the individual circumstances of the extinguishing system can likewise be realized only with a high outlay.

External pipework requires space and has to be adjusted during installation or suitably produced such that it has a visually attractive appearance, and, for example, vertical lines also actually run vertically and are also slightly exposed to forces during transport or installation which may lead, for example as a result of deformation, to leakages at connecting points.

Furthermore, fire extinguishing system valves are known in which external pipework is arranged in such a manner that the extinguishing agent flow from the water inlet side to a hydraulically operated alarm means, connected fluidically to the alarm means, such as, for example, a water-operated alarm bell, can be produced if a shut-off valve arranged in the pipework is opened. This external design is used, for example, if test alarms are intended to be carried out without having to move the closing body of the fire extinguishing system valve into the release position, which would result in flooding of the pipeline system.

In the priority application to the present application, the German patent and trademark office has searched the following prior art: DE 39 37 778 A1, DE 43 20 422 A1, DE 199 30 482A1, and WO 2011/065 580 A2.

The invention was accordingly based on the object of improving the fire extinguishing system valve and the fire extinguishing system of the type designated at the beginning to the effect that the disadvantages found in the prior art are overcome as substantially as possible. In particular, the invention was based on the object of specifying a fire extinguishing system valve which, in order to avoid a reduction in operational reliability, permits pressure fluctuations to be compensated for and at the same time requires as low an outlay on apparatus as possible. In particular, the invention was furthermore based on the object of specifying such a fire extinguishing system valve which can be realized on a fire extinguishing system with little outlay on installation and maintenance and/or without taking up space.

The invention achieves the object on which it is based in a fire extinguishing system valve of the type designated at the beginning by a bypass line which is integrated into the housing, is connected to the fluid inlet chamber in a fluid-conducting manner and extends away from there. Integration into the housing is understood according to the invention as meaning that the bypass line is partially or completely let into a wall and/or a cover or other mounting body of the housing which, by means of its direct coupling to the housing, becomes part of the housing. The invention follows the approach here of replacing the conventional, external pipework known from the prior art by integration into the housing component of the fire extinguishing system valve. The presumed increase in component complexity of the fire extinguishing valve housing is surprisingly nevertheless a simplification of the “fire extinguishing system” as a whole since, in comparison to the manufacturing of the housing, it obviates a significantly higher outlay on apparatus and significant working times for installing and maintaining the hitherto conventional, external fittings for the bypass line.

In a first preferred development, the integrated bypass line is connected to the fluid inlet chamber and the fluid outlet chamber in a fluid-conducting manner. With such a bypass line, extinguishing fluid can be fed in a simple manner in small volumetric flows from the supply-side fluid inlet chamber to the pipeline-side fluid outlet chamber without the risk of an erroneous alarm and without the risk of an inadvertent triggering of the sprinklers or nozzles.

The invention is advantageously developed by having a bypass shut-off member which is movable to and fro between a blocking state and a release state, in the release state, the fluid inlet chamber and the fluid outlet chamber are connected to each other in a fluid-conducting manner by means of the integrated bypass line, and in the blocking state, the fluid inlet chamber and the fluid outlet chamber are separated from each other. The shut-off member is preferably integrated in the housing. Furthermore preferably, the shut-off member is actuatable from outside the housing, either manually or by means of signaling activation. In particular, the signaling activatability enables detected pressure fluctuations to be compensated for from a spaced-apart fire alarm and/or extinguishing control panel without having to bring maintenance personnel to the fire extinguishing system in situ.

In a preferred embodiment, the housing, in particular the fluid inlet chamber, the fluid outlet chamber and the closing body or a valve seat cooperating with the closing body define a main volumetric flow between the fluid inlet chamber and the fluid outlet chamber depending on the extinguishing fluid pressure in the fluid inlet chamber, wherein the integrated bypass line defines a bypass volumetric flow, which is reduced relative to the main volumetric flow, between the fluid inlet chamber and the fluid outlet chamber depending on the extinguishing fluid pressure in the fluid inlet chamber. In this connection, the main and bypass volumetric flow is understood in each case as meaning the maximum possible volumetric flow which is dependent on the supply pressure. The main volumetric flow arises above all from the pressure loss between the fluid inlet chamber and fluid outlet chamber in the release state, i.e. with the closing body completely open. The possible main volumetric flow is furthermore dependent on the nominal width of the valve. The bypass volumetric flow is preferably designed to be smaller than a volumetric flow of extinguishing fluid which flows through a sprinkler or a nozzle during operation of a fire extinguishing system. For example, a wet alarm valve with a nominal width DN100 and a nominal pressure range of up to 16 bar can have a main volumetric flow within the range of 1000 l/min or more, in particular 2000 l/min or more, whereas the bypass volumetric flow lies within the range of 150 l/min or less, in particular 100 l/min or less.

In a further preferred embodiment, the integrated bypass line has at least one throttle element. The throttle element is preferably accessible from the outside, in particular is adjustable and/or replaceable from the outside. A targeted influencing of the bypass volumetric flow in comparison to the main volumetric flow can be undertaken by the throttle element.

Furthermore preferably, the integrated bypass line has at least one nonreturn element which is configured to release a fluid flow in the direction of the fluid outlet chamber and to prevent a fluid flow in the direction of the fluid inlet chamber. The nonreturn element is preferably accessible from the outside, and furthermore preferably is arranged replaceably in the housing of the fire extinguishing system valve.

In a further preferred refinement, the bypass line has one or more exits for the connection of pressure sensors. In such preferred embodiments in which a nonreturn element is provided, exits are preferably arranged upstream and downstream of the nonreturn element.

In a further preferred embodiment, the integrated bypass line has one or more flushing connections for the connection of a pressurized flushing medium source and introduction of the flushing medium into the integrated bypass line. The flushing medium used is preferably a flushing fluid, for example a gas or a liquid, but optionally also a fluid loaded with solids.

In a further preferred refinement, the fire extinguishing system valve has, on the integrated bypass line, a pressure relief exit which preferably has a shut-off element, in particular a safety valve or a bursting element, and is connected to the surroundings. The pressure relief exit can be used, for example, for emptying and/or venting.

The fire extinguishing system valve furthermore preferably has an alarm channel which is integrated in the housing and, at least in the release state of the closing body, is connected to the fluid inlet chamber and/or fluid outlet chamber in a fluid-conducting manner. By means of the alarm channel, extinguishing agent can flow to a hydraulically operated alarm means, which is fluidically connected to the alarm valve, such as, for example, a water-operated alarm bell, when the closing body is moved into the release state.

The integrated bypass line is furthermore preferably connected to the fluid inlet chamber and to the alarm channel in a fluid-conducting manner, preferably by means of an alarm channel exit. The alarm channel exit is preferably designed as part of the pressure relief exit. With said alarm channel bypass line, it is possible to carry out test alarms without an external outlay on apparatus and without having to move the closing body of the fire extinguishing system valve into the release position or out of the blocking position at all.

In a preferred embodiment, the fire extinguishing system valve has two bypass lines, wherein the bypass line extending from the fluid inlet chamber to the fluid outlet chamber is a first bypass line, and the bypass line (10a) (also alarm bypass line) extending from the fluid inlet chamber as far as the alarm channel is a second bypass line.

In a further preferred embodiment, the alarm channel is configured for connection to an alarm line, in particular alarm bell line.

Furthermore preferably, a nonreturn element is arranged in the alarm channel, said nonreturn element being configured to release a fluid flow in the direction of the alarm line or in the direction of the alarm means, and to prevent a fluid flow in the opposite direction.

In a particularly preferred refinement, the integrated bypass line has a particle filter.

In a further preferred embodiment, the integrated bypass line is formed in a housing part fastened in a reversibly releasable manner to the housing, preferably in a housing cover, particularly preferably in a hand hole cover. This permits particularly simple retrofitting of an integrated bypass line on a conventional fire extinguishing system valve already installed in a fire extinguishing system. A reversibly releasable connection is understood as meaning a connection which can in principle be produced and terminated as frequently as possible without damage to the connected parts, and wear can be disregarded because of the continuous correct operation. One example of a reversibly releasable connection is screw connections or clamping connections.

The invention has been described above with reference to the fire extinguishing system valve using a plurality of preferred embodiments. However, in a fire extinguishing system of the type referred to at the beginning, in particular in a sprinkler system with one or more fluid lines in which a fire extinguishing system valve for blocking and releasing the fluid line is arranged, the invention furthermore achieves the basic object by the fire extinguishing system valve being designed according to one of the preferred embodiments described above. With regard to the resultantly achieved advantages and the preferred embodiments of the fire extinguishing system, reference is made to the above embodiments of the fire extinguishing system valve.

The invention will be described in more detail below using preferred exemplary embodiments with reference to the attached figures, in which:

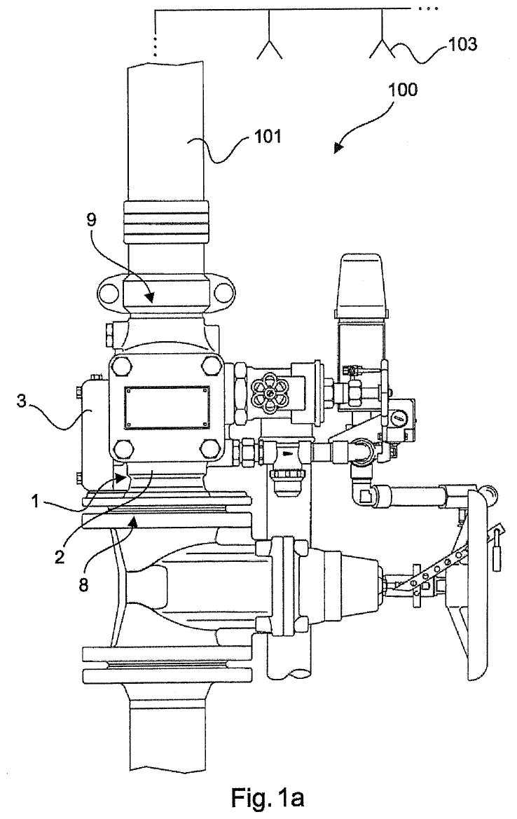

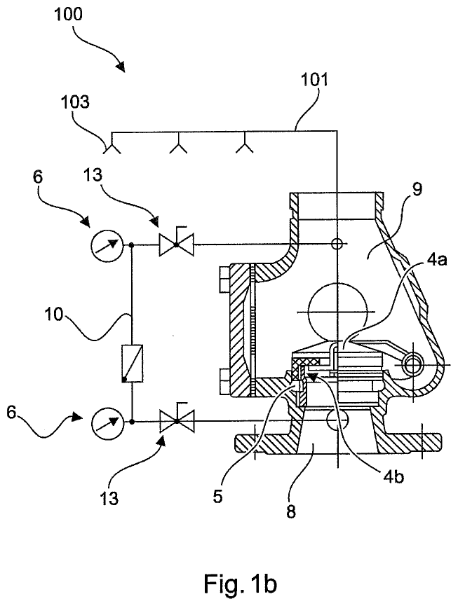

FIG. 1a shows a schematic illustration of a fire extinguishing system valve station of a fire extinguishing system according to the invention, with a fire extinguishing system valve according to a preferred exemplary embodiment,

FIG. 1b shows a schematic diagram of the connection of the fire extinguishing system valve according to FIG. 1a,

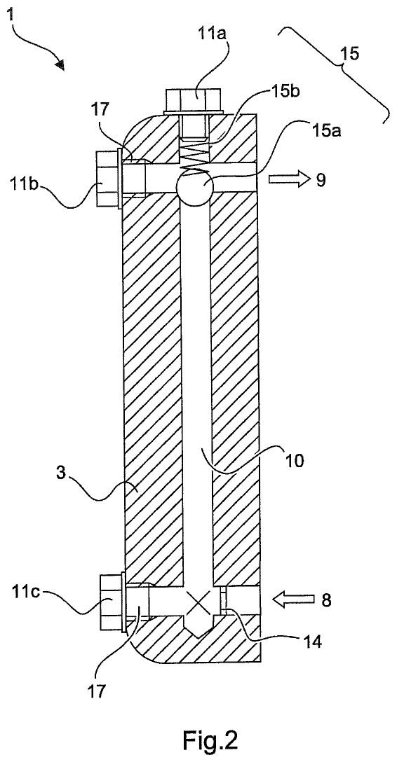

FIG. 2 shows a detailed illustration of part of the fire extinguishing system valve according to a first exemplary embodiment,

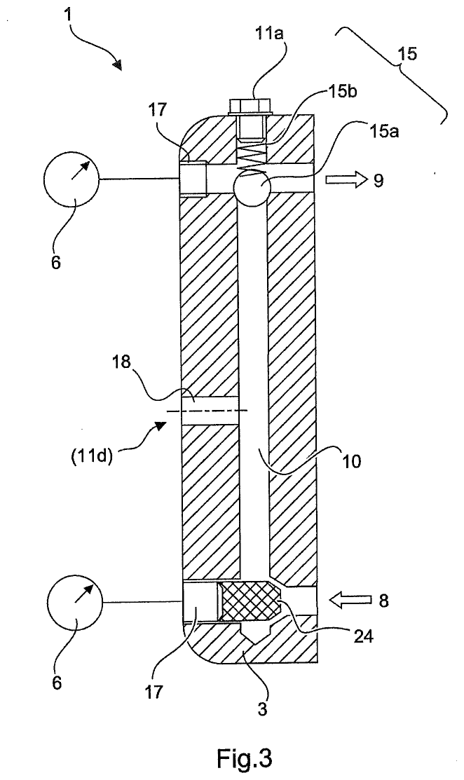

FIG. 3 shows a detailed illustration of the fire extinguishing system valve according

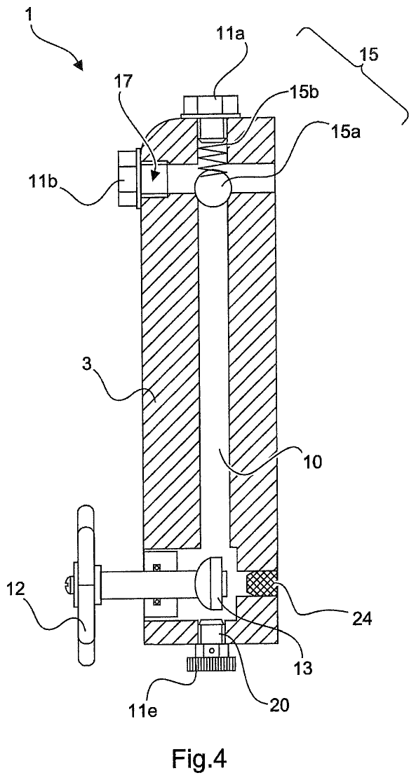

FIG. 4 shows a detailed illustration of the fire extinguishing system valve according to yet another exemplary embodiment, and

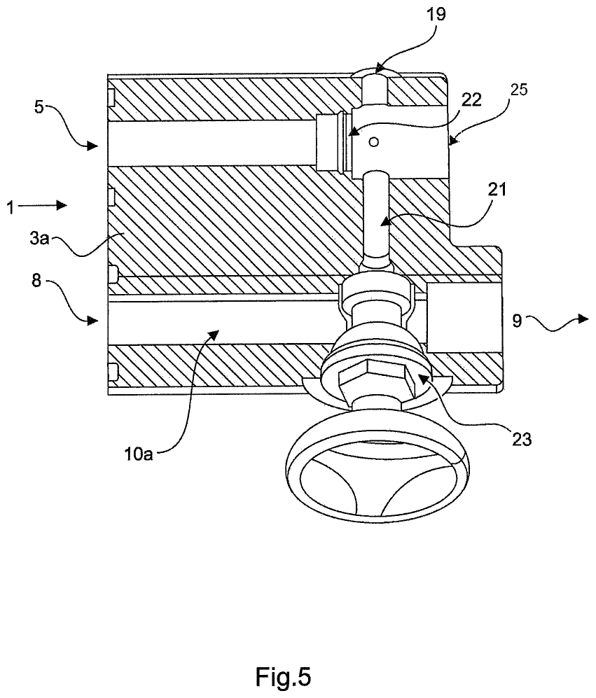

FIG. 5 shows a detailed illustration of the fire extinguishing system valve according to yet another exemplary embodiment.

A fire extinguishing system 100 is depicted systematically in FIGS. 1a, b. The fire extinguishing system 100 has one or more fluid lines 101 on which one or more sprinklers or nozzles 103 are provided. The fire extinguishing system 100 has a valve station with a fire extinguishing system valve 1. The fire extinguishing system valve 1 is preferably designed as a wet alarm valve and has a housing 2 to which a housing cover 3 is fastened in a reversibly releasable manner. The housing cover 3 is shown in various embodiments in FIGS. 2 to 5.

The fire extinguishing system valve 1 has a fluid inlet chamber 8 and a fluid outlet chamber 9 which, in a release state, communicate directly with each other and, in a blocking state, cannot communicate directly with each other. As emerges in particular from FIG. 1b, a closing body 4 which is movable to and fro between the blocking state and the release state is responsible for this function and, in the blocking state, rests in a fluidtight manner on a valve seat 4b. An alarm channel 5 is integrated in the housing 2 of the fire extinguishing system valve 1. When the closing body 4 is in the release position, it no longer rests on the valve seat 4b, no longer covers openings therein and therefore produces the fluidic connection between the fluid inlet chamber or fluid outlet chamber and the alarm channel 5. The alarm channel 5 extends as far as the outer side of the housing where an external alarm line can be connected.

Furthermore, the fire extinguishing system valve 1 has a bypass line 10 from the side of the fluid inlet chamber 8 as far as the side of the fluid outlet chamber 9. Bypass shut-off members 13 are provided in the bypass line 10, in each case on the inlet side and on the outlet side. Furthermore, one or more pressure sensors 6 are arranged in the bypass line 10.

The housing cover 3, shown in FIG. 2, of the fire extinguishing system valve 1 has a throttle element 14 in the bypass line 10. The throttle element 14 is preferably arranged at an exit 17 formed at the side of the fluid inlet chamber 8. Furthermore, the housing cover 3 has a nonreturn element 15 in the integrated bypass line 10, said nonreturn element having a ball 15a which is loaded by means of a spring 15b. The nonreturn element 15 is configured to release the fluid flow through the integrated bypass line 10 from the fluid inlet chamber 8 in the direction of the fluid outlet chamber 9 and to block same in the opposite direction. The fluid-conducting connection toward the fluid outlet chamber 9 is formed on the outlet side by a further exit 17. The integrated bypass line 10 and the exits 17 are preferably outwardly closed by means of closure elements 11a,b,c. The exits 17 and, with the latter, the throttle element 14 and the nonreturn element 15, are accessible from the outside via the closure elements 11a,b,c, which are connected in a reversibly releasable manner to the housing cover 3.

FIG. 3 shows a configuration of the fire extinguishing system valve 1 that slightly differs from the housing cover of FIG. 2. The fire extinguishing system valve 1 according to FIG. 3 additionally has a flushing connection 18 in the housing cover 3, which flushing connection can optionally be closed by a further closure element 11d. According to the exemplary embodiment from FIG. 3, respective pressure sensors 6 are connected at the exit 17.

Furthermore, a particle filter 24 is installed in the integrated bypass line 10 on the side of the fluid inlet chamber 8, said particle filter preferably being accessible from the outside through one of the exits 17 and being replaceable or cleanable. FIG. 4 in turn shows a slightly differing exemplary embodiment of the fire extinguishing system valve 1.

According to FIG. 4, the housing cover 3 has a bypass shut-off member 13 which is actuatable manually from the outside, preferably by means of a hand wheel 12. Additionally, a discharge exit 20 is provided on the housing cover 3, through which the integrated bypass line 10 can be relieved of pressure or emptied. In the operational orientation of the housing cover 3 on the fire extinguishing system valve 1, the discharge exit 20 is preferably oriented downward such that any fluid located in the integrated bypass line 10 can flow off download by means of gravity. The discharge exit 20 is closable by means of a closure element 11e.

FIG. 5 shows a detailed view of a further variant of the fire extinguishing system valve 1, which variant has an alarm channel bypass line 10a in which a shut-off member 23 is preferably arranged. The fire extinguishing system valve according to this variant can either have both the bypass line 10 (FIGS. 1 to 4) and the alarm bypass line 10a, or only the alarm channel bypass line 10a. A common feature of all of these variants is that a bypass line 10, 10a is integrated in the fire extinguishing system valve 1, either as a housing component let into a housing body or as an extension component connected directly to the housing, to some extent as a mounting block.

The alarm bypass line 10a is let into a mounting part 3a which can be the housing cover 3 according to FIGS. 1 to 4, a separate housing cover or a mounting block, but in each case is connected to the housing 2 of the fire extinguishing system valve 1 without pipework. The alarm channel 5 also extends through the mounting part 3a to an exit 25 to which an external alarm line can be connected.

The shut-off member 23 is controllable either manually or electrically and is configured to selectively release or to block the fluid-conducting connection between the integrated bypass line 10a and an alarm channel exit 21. The alarm channel exit 21 opens into the alarm channel 5 in which a further nonreturn element 22 is preferably provided. By means of actuation of the shut-off member 23, the alarm channel 5 can be flooded in a specific manner via the integrated bypass line 10a in order to be able to trigger a test alarm without having to open the closing body 4a between the fluid inlet chamber 8 and fluid outlet chamber 9 for this purpose. This is of advantage in particular in active alarm valves in which this would be associated with flooding of the pipe network downstream of the alarm valve.

The channel cross section of the integrated bypass line 10a is preferably selected in such a manner that an additional throttle for the throttle element 14 according to FIG. 2 is not absolutely necessary.

The exemplary embodiments of FIGS. 2 to 5 have each been explained separately above. However, the exemplary embodiments should not be understood as excluding one another. It is expressly within the context of the invention to combine the individual features of the respective FIGS. 2 to 5 with one another in order to obtain a multifunctional housing in which the invention is incorporated.

### LIST OF REFERENCE SIGNS

1 Fire extinguishing system valve

2 Housing

3 Housing cover

3a Mounting part

4a Closing body

4b Valve seat

5 Alarm channel

6 Pressure sensor

8 Fluid inlet chamber

9 Fluid outlet chamber

10 (First) bypass line

10a (Second) bypass line, alarm bypass line

11a, b, c, d, e Closure element

12 Hand wheel

13 Bypass shut-off member

14 Throttle element

15 Nonreturn element

17 Exit

18 Flushing connection

19 Pressure relief exit

20 Discharge exit

21 Alarm channel exit

22 Nonreturn element

23 Shut-off member

24 Particle filter

25 Alarm channel exit

100 Fire extinguishing system

101 Fluid line

103 Sprinkler or nozzle

1. A fire extinguishing system valve, comprising:
a housing which has a fluid inlet chamber, a fluid outlet chamber and a closing body which is movable to and fro between a blocking state and a release state, wherein, in the release state, the fluid inlet chamber and the fluid outlet chamber communicate with each other directly in a fluid-conducting manner, and, in the blocking state, the closing body prevents the direct communication between the fluid inlet chamber and the fluid outlet chamber,
at least one bypass line which is integrated in the housing, said bypass line being connected to the fluid inlet chamber in a fluid-conducting manner and extending away from there,
an alarm channel which, at least in the release state of the closing body, is connected to the fluid inlet and/or fluid outlet chamber in a fluid-conducting manner,
wherein the integrated bypass line is connected to the fluid inlet chamber and to the alarm channel, in a fluid conducting manner, by an alarm channel exit.

2. The fire extinguishing system valve as claimed in claim 1, wherein the bypass line is connected to the fluid inlet chamber and the fluid outlet chamber in a fluid-conducting manner.

3. The fire extinguishing system valve as claimed in claim 1, comprising a bypass shut-off member which is movable to and fro between a blocking state and a release state,
in the release state, the fluid inlet chamber and the fluid outlet chamber are connected to each other in a fluid-conducting manner by the integrated bypass line, and
in the blocking state, the fluid inlet chamber and the fluid outlet chamber are separated from each other.

4. The fire extinguishing system valve as claimed in claim 1, wherein the housing, the fluid inlet chamber, the fluid outlet chamber and the closing body or a valve seat cooperating with the closing body define a main volumetric flow between the fluid inlet chamber and the fluid outlet chamber depending on the extinguishing fluid pressure in the fluid inlet chamber, and wherein the integrated bypass line defines a bypass volumetric flow, which is reduced relative to the main volumetric flow, between the fluid inlet chamber and the fluid outlet chamber depending on the extinguishing fluid pressure in the fluid inlet chamber.

5. The fire extinguishing system valve as claimed in claim 1, wherein the integrated bypass line has at least one throttle element.

6. The fire extinguishing system valve as claimed in claim 1, wherein the integrated bypass line has at least one nonreturn element which is configured to release a fluid flow in the direction of the fluid outlet chamber and to prevent a fluid flow in the direction of the fluid inlet chamber.

7. The fire extinguishing system valve as claimed in claim 1, wherein the integrated bypass line has one or more exits for the connection of pressure sensors.

8. The fire extinguishing system valve as claimed in claim 1, wherein the integrated bypass line has one or more flushing connections for the connection of a pressurized flushing medium source and introduction of the flushing medium into the integrated bypass line.

9. The fire extinguishing system valve as claimed in claim 1, wherein the integrated bypass line has a pressure relief exit which preferably has a shut-off member, a safety valve or a bursting element, and is connected to the surroundings.

10. The fire extinguishing system valve as claimed in claim 1, wherein the at least one bypass line comprises two bypass lines, wherein a bypass line extending from the fluid inlet chamber to the fluid outlet chamber is a first bypass line, and a bypass line extending from the fluid inlet chamber as far as the alarm channel is a second bypass line.

11. The fire extinguishing system valve as claimed in claim 9, wherein the alarm channel exit is designed as part of the pressure relief exit.

12. The fire extinguishing system valve as claimed in one of claim 1, wherein the alarm channel is configured for connection to an alarm line, and wherein a nonreturn element is arranged in the alarm channel, said nonreturn element being configured to release a fluid flow in the direction of the alarm line and to prevent a fluid flow in the opposite direction.

13. The fire extinguishing system valve as claimed in claim 9, comprising a shut-off member for selectively releasing or blocking the pressure relief exit and/or the alarm channel exit.

14. The fire extinguishing system valve as claimed in claim 1, wherein the integrated bypass line has a particle filter.

15. The fire extinguishing system valve as claimed in claim 1, wherein the integrated bypass line is formed in a housing part fastened in a reversibly releasable manner to the housing as a housing cover of a hand hole.

16. A fire extinguishing system, comprising one or more fluid lines in which a fire extinguishing system valve for blocking and releasing the fluid lines is arranged, wherein the fire extinguishing system valve is designed as claimed in claim 1.
